(19) United States
(12) Patent Application Publication
(10) Pub. No.: US 2010/0240018 A1
(43) Pub. Date: Sep. 23, 2010

(54) Process for creating and administrating tests

(76) Inventor: Damion A. Bethune, Stone Mountain, GA (US)

Correspondence Address: BRYAN W. BOCKHOP, ESQ.;BOCKHOP & ASSOCIATES, LLC, 2375 MOSSY BRANCH DR., SNELLVILLE, GA, 30078, US

(21) Appl. No.: 12/723,957

(22) Filed: Mar. 15, 2010

Related U.S. Application Data
(63) Continuation-in-part of application No. 11/700,164, filed on Jan. 30, 2007, now abandoned.

(51) Int. Cl. G09B 5/00; G09B 7/00

(52) U.S. Cl. 434/309; 434/335

(57) ABSTRACT

A system for presenting a test to a user that includes portable hand-held media device and an application resident in the memory. The portable hand-held media device includes a digital memory, a user input and an output that includes a display. The application is configured to generate a test template that is configured to receive a test input. The test template includes a question input field for receiving a question; a plurality of answer input fields for receiving a plurality of answers corresponding to the question; and a correct answer indication input for receiving an indication which of the plurality of answers of a correct answer. The application is also configured to store a digital representation of the test onto the digital memory. The application is also configured to present a selected question of the plurality of questions to the user on the display. The application is also configured to receive an input from the user input corresponding to a user-selected answer of the plurality of answers corresponding to the selected question. The application is also configured to compare the user-selected answer to the correct answer corresponding to the selected question. The application is also configured to present to the user an indication that the user-selected answer is correct if the user-selected answer is the same as the correct answer. Otherwise, the application is also configured to present to the user an indication that the user-selected answer is not correct.

### CROSS-REFERENCE TO RELATED APPLICATION(S)

This application is a continuation-in-part of, and claims the benefit of, U.S. patent application Ser. No. 11/700,164, filed Jan. 30, 2007, the entirety of which is hereby incorporated herein by reference.

### BACKGROUND OF THE INVENTION

1. Field of the Invention

The present invention relates to applications configured to run on hand-held portable media devices and, more specifically, to a system for presenting tests and examinations on hand-held portable media devices.

2. Description of the Related Art

Many people employ practice exams to study for tests in a variety of areas. For example, it is common for aspiring law students to take several Law School Admissions Test sample examinations prior to taking the Law School Admissions Test. However, given the busy schedules people are under, it can be hard for some people to find the time necessary to take practice exams.

Studying can be done using recorded audio materials. Some people can record study materials on a recording device. However, such recording is not interactive and can result in the user going over already learned information and wasting time and losing the user's interest.

Currently practice examinations are not generated for use with portable hand-held media devices. If a person who is practicing a test is studying a paper version of the test, time can be wasted.

Therefore, there is a need for a system that presents practice examinations in a portable format.

### SUMMARY OF THE INVENTION

The disadvantages of the prior art are overcome by the present invention which, in one aspect, is a system for presenting a test to a user that includes portable hand-held media device and an application resident in the memory. The portable hand-held media device includes a digital memory, a user input and an output that includes a display. The application is configured to generate a test template that is configured to receive a test input. The test template includes a question input field for receiving a question; a plurality of answer input fields for receiving a plurality of answers corresponding to the question; and a correct answer indication input for receiving an indication which of the plurality of answers of a correct answer. The application is also configured to store a digital representation of the test onto the digital memory. The application is also configured to present a selected question of the plurality of questions to the user on the display. The application is also configured to receive an input from the user input corresponding to a user-selected answer of the plurality of answers corresponding to the selected question. The application is also configured to compare the user-selected answer to the correct answer corresponding to the selected question. The application is also configured to present to the user an indication that the user-selected answer is correct if the user-selected answer is the same as the correct answer. Otherwise, the application is also configured to present to the user an indication that the user-selected answer is not correct.

In another aspect, the invention is a method for presenting a test to a user via a portable hand-held media device, including a digital memory, a user input and an output that includes a display, in which a test template is generated on the display. The test template is configured to receive a test input and that includes: a question input field for receiving a question; a plurality of answer input fields for receiving a plurality of answers corresponding to the question; a correct answer indication input for receiving an indication which of the plurality of answers of a correct answer. A digital representation of the test is stored onto the digital memory. A selected question of the plurality of questions is presented to the user on the display. An input is received from the user input corresponding to a user-selected answer of the plurality of answers corresponding to the selected question. The user-selected answer is compared to the correct answer corresponding to the selected question. If the user-selected answer is the same as the correct answer then an indication that the user-selected answer is correct is presented to the user, otherwise an indication that the user-selected answer is not correct is presented to the user

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a flowchart showing operation of one embodiment of the invention.

FIG. 2 is a flowchart showing one method of generating a test.

FIG. 3 is a flowchart showing a manual setup of a test from the handheld device.

FIG. 4 is a screen shot showing a representative question input screen

FIG. 5 is a plan view of a portable hand-held media device displaying a representative test template.

FIG. 6 is a screen shot of an example of a closed system on a hand held device

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet.

One embodiment is a system for presenting a test to a user on a portable hand-held media device (e.g., a iPod®, a mobile telephone, etc.). The portable hand-held media device includes a digital memory, a user input (such as a touch screen) and an output that includes a display and an audio output circuit. The portable hand-held media device can also include digital speech synthesizer. An application for recording and presenting tests resides on the digital memory.

The system allows users to enter or download tests, such as practice examinations, and then play them back on a mobile hand-held media device. The system presents questions from the test and allows the user to input a selected answer. The system then determines if the answer is correct and then displays to the user an indication of which answer is correct. The system can keep a tally of correct answers and present the user with a final score once the test is completed.

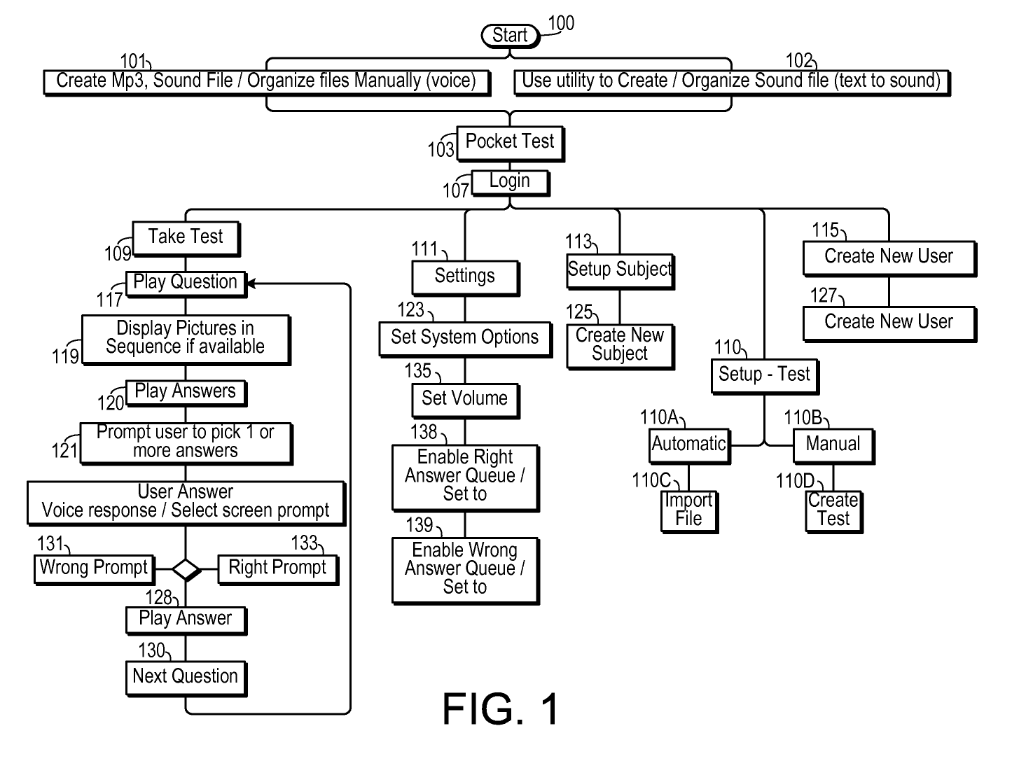

As shown in FIG. 1, in one embodiment, the application starts 100 and the system either creates sound files of stored questions and corresponding answers 101 or it synthesizes entered text of the questions and answers into sound files 102. The test is stored 103 in the digital memory. Alternatively, test data can be downloaded onto the media device from a remote computer via the global computer network.

When the user wants to use the system, a login routine 107 is executed and the user is presented with the following options: take a test 109, change settings 111, setup a subject 113, setup a test 110, or create a new user 115.

If the user wants to take a test 109, the system plays a question 113 and any corresponding pictures 119 (if available). The system also presents a plurality of answers 120 corresponding to each question and the user is prompted to pick an answer 121 (or several answers is there is more than one correct answer). Once the user has selected an answer, the system determines where the user selected the right answer 133 or the wrong answer 131. The correct answer is played 128 and then the system goes on to the next question 130 while unanswered questions remain.

If the user elects to change the settings 111, the system will allow the user to set system options 123, set the audio output volume 135, enable generation of a right answer queue 138 and a wrong answer queue 139.

If the user elects to setup a subject 113, the user will be allowed to create a new subject 125 of a test.

If the user elects to setup a test 110, the user can use an automatic routine 110A to import a test data file 110C from the global computer network. Alternatively, the user can manually 110B enter a test. With this option, the user creates a test 110D by generating questions and corresponding answers, and then entering them into the system.

The user can create a new user 115 by entering new user profile information into the system 127. The system allows the user to open the program and login to the test. The handheld device is able to keep track of users' progress and users are able to go over new material they need help with because the system will remember how well they did the last time.

After login, the user can take a test, adjust the system setting, create a new subject create a new test and create new user. The adjusting of the system settings include features like selecting the right or wrong threshold where for example if the user gets the problem wrong a certain amount of times, which may be a problem area for the user. The user will be asked this question repeatedly until he or she gets it right a certain amount of times. After the user gets the question right a sufficient number of times, this question will be treated as learned knowledge and the user may not be asked this question again. The setting feature can also control the speed of the sound file playing the quality of the sound and image played and displayed

The user can create and organize sound files manually by using a separate text to speech utility, a separate sound file recorder or use the one that come in this system. When using this device for input the user can play a sound bite to hear them before saving them. When inputting questions and answers the user has a choice of using a voice recording or changing text to speech. After inputting the questions and answers the user then picks predetermined answer like in a multiple choice test. After inputting this information the saves each page of the test until reaching the last page where they can compile the test creating one folder or file in that can be put on a server and download from the handheld, transfer from server to handheld by a synching method or put on an SD card, or similar memory device. In one embodiment, the user can create a test subject then use the camera on the portable handheld device (for example PDA with a camera) and use that picture

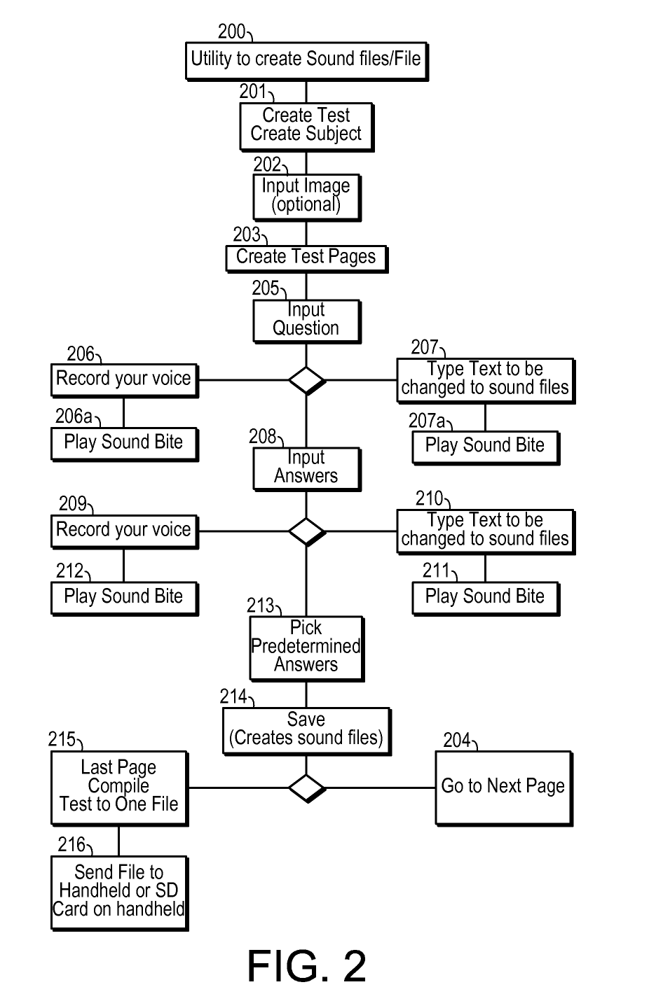

In creating a test, as shown in FIG. 2, the user can create sound files 200 corresponding to the test. In doing so, the user sets up a test subject 201 and can input an image corresponding the subject 202. Next the user creates individual test pages 203 by inputting a series of questions 205, either by recording voice versions of the questions 206 and playing corresponding sound bites 206A, or by inputting text 207 that is converted to sound files 207A. Next the user inputs the possible answers 208 to the question. This may be done by either by recording voice versions of the answers 207 and playing corresponding sound bites 207A. Then the user indicates which answer (or answers) is correct 213 and the user inputs are saved to memory 214. The data is compiled into the standard test format 215 and is then transferred to the hand-held device 216 if the test is being generated on a remote computer. Then the system will go on to a next page 204.

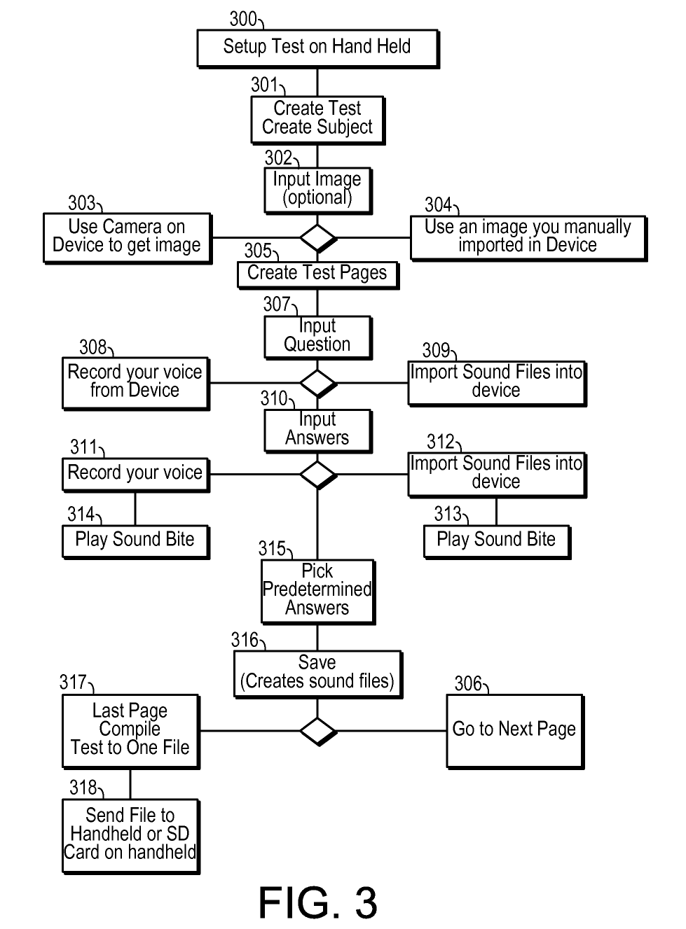

In another embodiment of generating a test 300, as shown in FIG. 3, the user creates a test subject 301 and optionally inputs an image 302 corresponding to the subject. To do this, the user can use a digital camera on the hand-held device 303 to capture an image, or the user can import a downloaded image 304. The user creates test pages 305 by inputting a series of questions 307. This can be done by recording voice representations of questions 308 or by importing pre-recorded sound files 309 of the questions. The user then inputs corresponding answers 310, again by recording voice representations thereof 311 or by importing sound files corresponding to the answers 312. The answers can be verified through playback 313 and 314. The user also designates the correct answers 315 and the corresponding data is saved while the sound files are created 316. After each question is entered, the system goes on to a next page 308 until the last page has been entered 317, at which point the data is compiled into the standard test format 317 and is stored onto the device's memory 318.

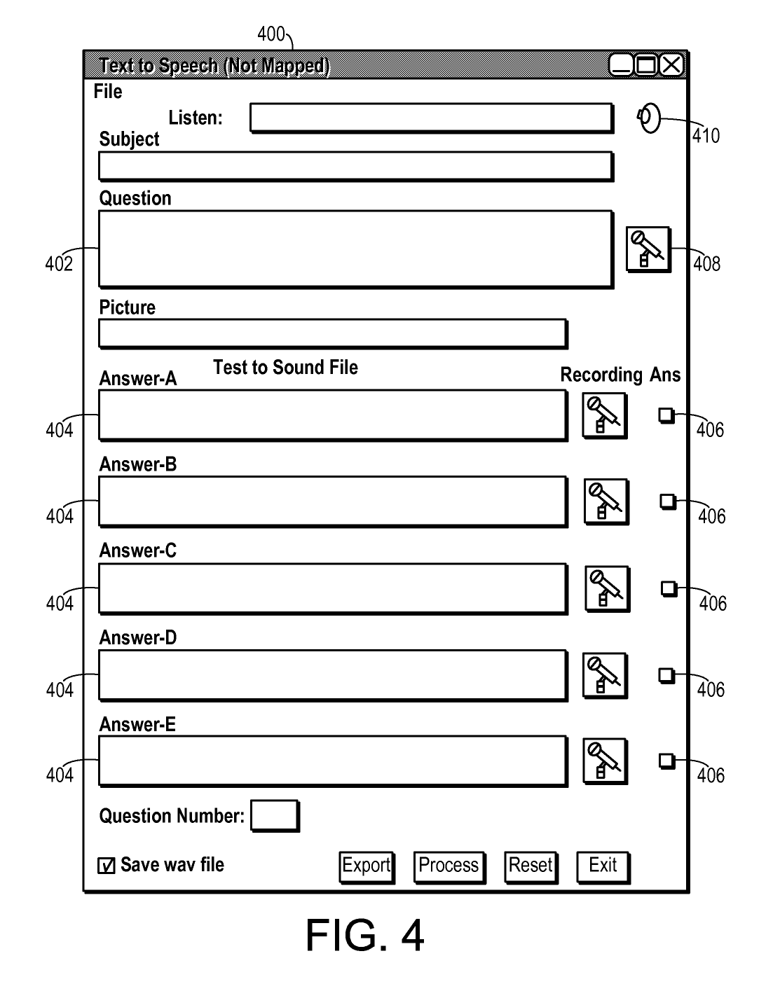

One representative test question data input screen 400 shown in FIG. 4. This screen provides the user with a template for entering a question 402 and a plurality of corresponding answers 404, along with check boxes 406 for designating the correct answers. Audio recording buttons 408 are also provided to allowing recording of the questions and answers, as well as a playback button 410.

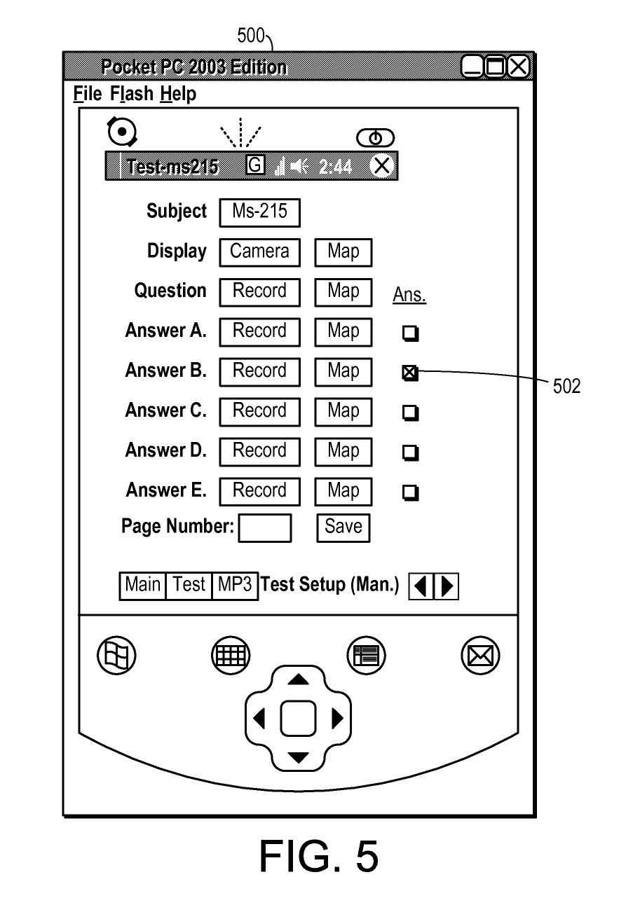

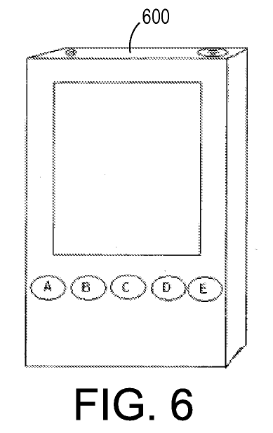

One embodiment of a display on a hand-held device 500 on which a question and the corresponding answers is shown in FIG. 5. In this example, the questions and the answers are presented in an audio format speech representation of the question and answers and the user selects the answer to the test by touching a check box 502 corresponding to the selected answer. One embodiment of a hand-held device 600 adapted for taking tests is shown in FIG. 6.

The system includes an application stored on the device's memory. In one embodiment, in generating the test, the application is configured to receive a voice representation of the question, receive voice representations of the answers and digitize and store the voice representation of the question and the voice representations of the answers. This embodiment is an example of a closed system. This is a device can be adapted primary to use this process. There can be addition accessories or software added to the handheld system where in a closed system you may not have additional software or utilities.

The output can include an audio output and the question can be presented by generating an audio representation of the question and playing the audio representation on the audio output. A digital speech synthesizer can be installed on the portable hand-held media device. In such an embodiment, the test input is entered in a text format and the speech synthesizer generates an audio speech representation of the question when the question is presented to the user.

In one embodiment, the portable hand-held media device can be couplable to a global computer network and the test input can receive data from a remote computer via the global computer network.

One embodiment is a process that allows the user to format sound into a test will allow the user to use text and convert it to sound or use voice recording and make sound files for the purpose of making a test. The user would make sound file of question and a predefined number of answer from this create the test. This process and be put on existing hand held platform (open system examples include Compaq's Ipaq, Dell's Axim and Palm's PDA) or distributed on a closed handheld system. Thus, it can be sold as a new type of media player or a process for creating and administering test on a handheld device that measure performance and keep record of your performance for the purpose of skipping the questions that you know and focusing on the questions you get wrong. The utility or file distribution system in one example can operate on Macintosh and OS2 platform. This system is not limited to a multiple choice questions or true and false test since the user can use voice inputs to make choices.

One advantage to this system is portability and interactivity; which allow the users to study in places where they would normally not be able to study. Interactivity will keep users focused on what they are learning. Interactivity also allows to program to track what questions users need the most work on and keep users focused on the areas they need help in. The combination of these advantages make studying more effective, increase there chances of passing the test and learning experience more enjoyable one.

In some embodiments where voice recordings are not interactive, the system would use a sound bite to prompt the user to answer the question by touching a button on the screen or voice using there own voice to answer the question. This method will not let the user lose portability when using their handheld device

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A system for presenting a test to a user, comprising:
a. a portable hand-held media device, including a digital memory, a user input and an output that includes a display; and
b. an application resident in the memory and configured to:
i. generate a test template that is configured to receive a test input and that includes: a question input field for receiving a question; a plurality of answer input fields for receiving a plurality of answers corresponding to the question; and a correct answer indication input for receiving an indication which of the plurality of answers of a correct answer;
ii. store a digital representation of the test onto the digital memory;
iii. present a selected question of the plurality of questions to the user on the display;
iv. receive an input from the user input corresponding to a user-selected answer of the plurality of answers corresponding to the selected question;
v. compare the user-selected answer to the correct answer corresponding to the selected question; and
vi. when the user-selected answer is the same as the correct answer then present to the user an indication that the user-selected answer is correct, otherwise present to the user an indication that the user-selected answer is not correct.

2. The system of claim 1, wherein the user output comprises an audio output device and wherein the application is further configured to present the selected question by generating a speech representation of the selected question.

3. The system of claim 1, wherein the application is further configured to maintain a tally of correct answers and to display the number of correct answers entered by the user.

4. The system of claim 1, wherein the user input comprises a voice recording device and wherein the application is further configured to:
a. receive a voice representation of the question;
b. receive voice representations of the answers; and
c. digitize and store the voice representation of the question and the voice representations of the answers.

5. The system of claim 4, wherein the output comprises an audio output and wherein the question is presented by generating an audio representation of the question and playing the audio representation on the audio output.

6. The system of claim 1, further comprising a digital speech synthesizer installed on the portable hand-held media device and wherein the test input is entered in a text format and wherein the speech synthesizer generates an audio speech representation of the question when the question is presented to the user.

7. The system of claim 1, wherein the portable hand-held media device is couplable to a global computer network and wherein the test input receives data from a remote computer via the global computer network.

8. A method for presenting a test to a user via a portable hand-held media device, including a digital memory, a user input and an output that includes a display, the method comprising the steps of:
a. generating on the display a test template that is configured to receive a test input and that includes: a question input field for receiving a question; a plurality of answer input fields for receiving a plurality of answers corresponding to the question; and a correct answer indication input for receiving an indication which of the plurality of answers of a correct answer;
b. storing a digital representation of the test onto the digital memory;
c. presenting a selected question of the plurality of questions to the user on the display;
d. receiving an input from the user input corresponding to a user-selected answer of the plurality of answers corresponding to the selected question;
e. comparing the user-selected answer to the correct answer corresponding to the selected question; and
f. when the user-selected answer is the same as the correct answer then presenting to the user an indication that the user-selected answer is correct, otherwise presenting to the user an indication that the user-selected answer is not correct.

9. The method of claim 8, wherein the user output comprises an audio output device and wherein the application is further configured to present the selected question by generating a speech representation of the selected question.

10. The method of claim 8, wherein the application is further configured to maintain a tally of correct answers and to display the number of correct answers entered by the user.

11. The method of claim 8, wherein the user input comprises a voice recording device and wherein the application is further configured to:
a. receive a voice representation of the question;
b. receive voice representations of the answers; and
c. digitize and store the voice representation of the question and the voice representations of the answers.

12. The method of claim 11, wherein the output comprises an audio output and wherein the question is presented by generating an audio representation of the question and playing the audio representation on the audio output.

13. The method of claim 8, further comprising a digital speech synthesizer installed on the portable hand-held media device and wherein the test input is entered in a text format and wherein the speech synthesizer generates an audio speech representation of the question when the question is presented to the user.

14. The method of claim 8, wherein the portable hand-held media device is couplable to a global computer network and wherein the test input receives data from a remote computer via the global computer network.
